(19) United States
(12) Patent Application Publication
(10) Pub. No.: US 2026/0212531 A1
(43) Pub. Date: Jul. 23, 2026

(54) MEASURING COLOR ALIGNMENT OF IMAGES GENERATED BY ARTIFICIAL INTELLIGENCE

(71) Applicant: SAP SE, Walldorf (DE)

(72) Inventors: Junxiang Jia, Singapore (SG); Laddie Ji Cheng Tan, Singapore (SG); Louise Tan, Singapore (SG); Zhen Shu, Singapore (SG); Davis Dudchock, Nashville, TN (US)

(21) Appl. No.: 19/034,723

(22) Filed: Jan. 23, 2025

(51) Int. Cl. G06T 7/90; G06T 11/00; G06V 10/56; G06V 10/74; G06V 10/762

(52) U.S. Cl. CPC G06T 7/90; G06T 11/10; G06V 10/56; G06V 10/761; G06V 10/762; G06T 2207/10024

(57) ABSTRACT

Methods, systems, and computer-readable storage media for receiving an image and a reference color scheme, the image being generated by an AI model, the reference color scheme having populated a prompt that the image was generated in response to, for each pixel in the image, generating a color space vector representative of a color represented by the pixel to provide a set of vectors, processing the set of vectors to define a set of clusters, each cluster representative of colors of a sub-set of vectors, for each cluster in the set of clusters and for each color in the reference color scheme, determining a similarity score that is included in a set of similarity scores, calculating a color alignment metric based on the set of similarity scores, determining a color alignment result based on the color alignment metric, and executing one or more tasks responsive to the color alignment result.

### BACKGROUND

Enterprises execute a multitude of workflows, each including a series of underlying tasks, in order to perform enterprise operations. Execution of workflows can be performed across multiple data centers, systems, and platforms. For example, workflows can be executed within and/or across an enterprise resource planning (ERP) system, a human capital management (HCM) system, and a customer relationship management (CRM) system, to name a few. Enterprises continuously seek to improve and gain efficiencies in their operations. To this end, enterprises integrate systems in the domain of so-called intelligent enterprise, which can employ artificial intelligence (AI). For example, AI can be used for data analytics and/or automating tasks in support of enterprise operations. AI, however, presents technical hurdles, disadvantages, and risks that need to be mitigated in use by enterprises.

### SUMMARY

Implementations of the present disclosure are directed to measuring color alignment of images that are generated using artificial intelligence (AI). More particularly, implementations of the present disclosure are directed to using an evaluation metric to automatically determine whether colors of AI-generated images are aligned with reference color schemes used to generate the AI-generated images.

In some implementations, actions include receiving an image and a reference color scheme, the image being generated by an AI model, the reference color scheme having populated at least a portion of a prompt that the image was generated in response to, for each pixel in the image, generating a color space vector representative of a color represented by the pixel to provide a set of vectors, processing the set of vectors to define a set of clusters, each cluster representative of colors of a sub-set of vectors, for each cluster in the set of clusters and for each color in the reference color scheme, determining a similarity score that is included in a set of similarity scores, calculating a color alignment metric based on the set of similarity scores, determining a color alignment result based on the color alignment metric, and executing one or more tasks responsive to the color alignment result. Other implementations of this aspect include corresponding systems, apparatus, and computer programs, configured to perform the actions of the methods, encoded on computer storage devices.

These and other implementations can each optionally include one or more of the following features: each color space vector includes a red channel value, a green channel value, and a blue channel value; processing the set of vectors to define a set of clusters includes processing the set of vectors using a K-means clustering algorithm; each similarity score is determined as a cosine similarity between a reference color in the reference color scheme and a cluster centroid of a respective cluster; each similarity score is weighted based on a pixel count of a respective cluster; the color alignment metric is determined as a sum of similarity scores weighted by a total number of color space values provided in the reference color scheme; and the one or more tasks include modifying the prompt to provide a modified prompt and generating another image using the modified prompt.

The present disclosure also provides a computer-readable storage medium coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

It is appreciated that methods in accordance with the present disclosure can include any combination of the aspects and features described herein. That is, methods in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### DESCRIPTION OF DRAWINGS

FIG. 1 depicts an example architecture that can be used to execute implementations of the present disclosure.

FIG. 2 depicts an example conceptual architecture for evaluating color alignment of AI-generated images in accordance with implementations of the present disclosure.

FIG. 3 depicts example color alignment evaluations using different color schemes in accordance with implementations of the present disclosure.

FIG. 4 depicts a pipeline for color alignment evaluation in accordance with implementations of the present disclosure.

FIG. 5 depicts an example process that can be executed in accordance with implementations of the present disclosure.

FIG. 6 is a schematic illustration of example computer systems that can be used to execute implementations of the present disclosure.

Like reference symbols in the various drawings indicate like elements.

### DETAILED DESCRIPTION

Implementations of the present disclosure are directed to measuring color alignment of images that are generated using artificial intelligence (AI). More particularly, implementations of the present disclosure are directed to using an evaluation metric to automatically determine whether colors of AI-generated images are aligned with reference color schemes used to generate the AI-generated images.

Implementations can include actions of receiving an image and a reference color scheme, the image being generated by an AI model, the reference color scheme having populated at least a portion of a prompt that the image was generated in response to, for each pixel in the image, generating a color space vector representative of a color represented by the pixel to provide a set of vectors, processing the set of vectors to define a set of clusters, each cluster representative of colors of a sub-set of vectors, for each cluster in the set of clusters and for each color in the reference color scheme, determining a similarity score that is included in a set of similarity scores, calculating a color alignment metric based on the set of similarity scores, determining a color alignment result based on the color alignment metric, and executing one or more tasks responsive to the color alignment result.

To provide further context for implementations of the present disclosure, in the field of artificial intelligence (AI), generative AI (GAI) has seen an explosion in popularity. GAI can be described as including foundation models that generate content based on training data. For example, foundation models can include text-to-image (T2I) models that receive a textual description of an image as input (prompt) and generate images based on the textual description. T2I models bridge the gap between vision and language. The increasing power and popularity of GAI has seen enterprises seeking avenues to leverage GAI in improving enterprise operations. However, integrating GAI into enterprise platforms is a non-trivial task. For example, GAI can present various technical challenges and can have disadvantages that have to be managed. The technical challenges and risks did not exist in the pre-GAI world.

To highlight this, an example domain for an enterprise-level application and an example use case within the example domain can be considered. The example domain includes human capital management (HCM) and the example use case includes providing training materials for training of employees. In the example domain and use case, an enterprise can leverage a GAI system that provides one or more T2I models to generate images in response to textual descriptions (i.e., AI-generated images). In the example use case, the AI-generated images can be used to populate training materials that are used to train employees of the enterprise. While implementations of the present disclosure are described in further detail herein with reference to the example domain of HCM and the example use case of generating training materials, it is contemplated that implementations of the present disclosure can be realized in any appropriate domain and/or any appropriate use case.

GAI models are frequently imprecise in generating content responsive to prompts (input). For example, T2I models can be imprecise in generating images responsive to prompts. In some instances, imprecision can be large and easy to detect (e.g., visual inspection by a human). In some instances, imprecision can be small and not easily detectable. Evaluation metrics can be used to evaluate the alignment of AI-generated images and respective prompts (e.g., how precise an AI-generated image is with respect to the prompt that the AI-generated image is generated in response to). Such evaluation metrics can be categorized into image quality, textual alignment, and user preferences.

Current evaluation metrics primarily focus on assessing the semantic alignment between the image and the input text (prompt) or measuring the overall quality and diversity of the image. However, color is a crucial component in both the image and prompt, conveying specific emotions, themes, visual identity, and the like. For example, and in the enterprise context, it can be critical that AI-generated images align with branding and/or trademark color schemes. However, the existing evaluation metrics do not explicitly measure how accurately GAI models capture or reproduce the intended color schemes. The oversight on color evaluation leads to generated images that may be semantically accurate, but fail to meet the necessary aesthetic standards. This can also affect the ability of the GAI model to maintain brand consistency and visual coherence. Accordingly, there is a need for metrics that explicitly assess color accuracy (alignment with respect to reference color schemes) in AI-generated images.

In view of the above context, implementations of the present disclosure provide approaches to automatically detecting color alignment of AI-generated images. As described in further detail herein, implementations of the present disclosure provide an evaluation metric that is used to assess how well an image generated by a GAI model (e.g., a T2I model) aligns with a reference color scheme (e.g., red, green, and blue (RGB) values) specified in the prompt that the image is generated in response to.

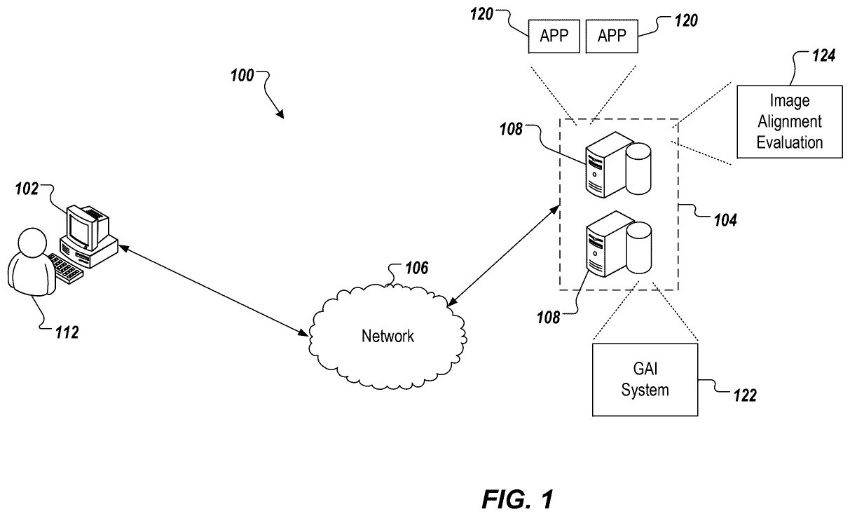

FIG. 1 depicts an example architecture 100 in accordance with implementations of the present disclosure. In the depicted example, the example architecture 100 includes a client device 102, a network 106, and a server system 104. The server system 104 includes one or more server devices and databases 108 (e.g., processors, memory). In the depicted example, a user 112 interacts with the client device 102.

In some examples, the client device 102 can communicate with the server system 104 over the network 106. In some examples, the client device 102 includes any appropriate type of computing device such as a desktop computer, a laptop computer, a handheld computer, a tablet computer, a personal digital assistant (PDA), a cellular telephone, a network appliance, a camera, a smart phone, an enhanced general packet radio service (EGPRS) mobile phone, a media player, a navigation device, an email device, a game console, or an appropriate combination of any two or more of these devices or other data processing devices. In some implementations, the network 106 can include a large computer network, such as a local area network (LAN), a wide area network (WAN), the Internet, a cellular network, a telephone network (e.g., PSTN) or an appropriate combination thereof connecting any number of communication devices, mobile computing devices, fixed computing devices and server systems.

In some implementations, the server system 104 includes at least one server and at least one data store. In the example of FIG. 1, the server system 104 is intended to represent various forms of servers including, but not limited to a web server, an application server, a proxy server, a network server, and/or a server pool. In general, server systems accept requests for application services and provide such services to any number of client devices (e.g., the client device 102 over the network 106).

In accordance with implementations of the present disclosure, and as noted above, the server system 104 can host one or more GAI-based applications 120 that are provisioned to support enterprise-level operations. Here, a GAI-based application 120 can include an application that executes one or more tasks using GAI. In some examples, the server system 104 hosts a GAI system 122. For example, the GAI system 122 can be provided by a third-party (e.g., DALL-E provided by OpenAI). In some examples, the GAI-based application 120 queries (e.g., prompts) the GAI system 122, which returns a response that is responsive to the query. In the context of the present disclosure, the query can be a prompt that provides a textual description of an image that is to be generated by the GAI system 122 (e.g., by a T2I model hosted in the GAI system 122). The response is an image that is generated by the GAI system 122.

With continued reference to FIG. 1, the server system 104 can host an image alignment evaluation system 124 that automatically evaluates alignment of images output by the GAI system 122 with prompts input by the one or more GAI-based applications 120. Although the image alignment evaluation system 124 is represented as a separate system, it is contemplated that the image alignment evaluation system 124 can be part of another system. For example, the image alignment evaluation system 124 can be provided within a GAI-based application 120 (e.g., each GAI-based application 120 can include an image alignment evaluation system 124). As described in further detail herein, and among other evaluation perspectives, the image alignment evaluation system 124 uses an evaluation metric to automatically determine whether colors of AI-generated images are aligned with prompts used to generate the AI-generated images.

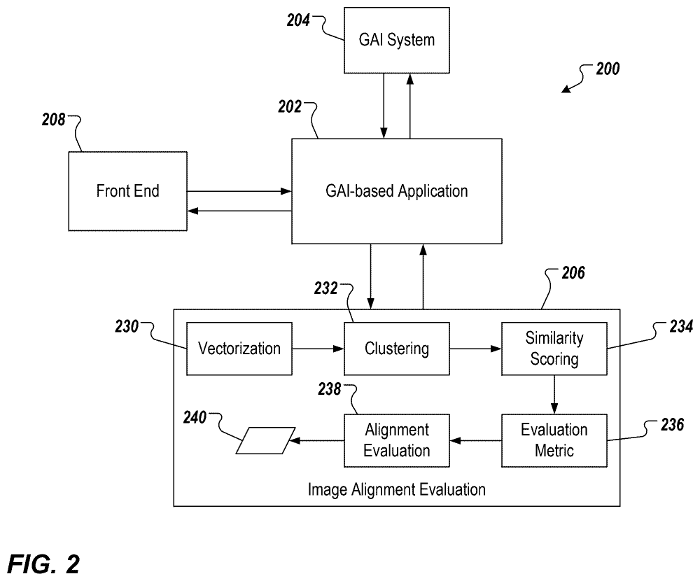

FIG. 2 depicts an example conceptual architecture 200 in accordance with implementations of the present disclosure. In the depicted example, the conceptual architecture 200 includes a GAI-based application 202, a GAI system 204, an image alignment evaluation system 206, and a front end 208. In some examples, the GAI-based application 202 (e.g., a GAI-based application 120 of FIG. 1) leverages a GAI model hosted by the GAI system 204 (e.g., the GAI system 122 of FIG. 1) to execute one or more tasks in support of an enterprise. With non-limiting reference to the example domain and the example use case, the GAI-based application 202 can prompt the GAI system 204 to generate images for use in training materials to train employees of the enterprise.

In some implementations, a user (e.g., the user 112 of FIG. 1) interacts with the GAI-based application 202 using the front end 208 (e.g., provided on the client device 102). In some examples, the front end 208 can include one or more user interfaces (UIs) that enable the user to provide input to and receive output from the GAI-based application 202. For example, the user can provide input to the front end 208 that can be used by the GAI-based application 202 to prompt the GAI system 204, as described in further detail herein.

In the context of the present disclosure, the image alignment evaluation system 206 evaluates a color alignment of images generated by the GAI system 204 with reference color schemes provided in prompts. In the example of FIG. 2, the image alignment evaluation system 206 includes a vectorization module 230, a clustering module 232, a similarity scoring module 234, an evaluation metric determination module 236, and an alignment evaluation module 238. In some examples, the image alignment evaluation system 206 generates, for each image evaluated, a result 240 that indicates whether the image aligns with a reference color scheme. The reference color scheme can be defined as a color map that represents colors included within the reference color scheme.

In further detail, the user can provide input to the GAI-based application 202 (e.g., through the front end 208) that can be used to prompt the GAI system 204 to generate an image. In some examples, the user input can indicate a reference color scheme that is to be used to generate the image. In some examples, the reference color scheme includes a set of colors, each color being indicated by a respective hexadecimal (hex) value that can be mapped to one or more color spaces, such as red, green, blue (RGB) and cyan, magenta, yellow, black (CMYK). For purposes of non-limiting illustration, an example color, which can generally be described as a very dark desaturated blue, is assigned hex #2b3a67, which is composed of 16.9% red, 22.7% green, and 40.4% blue in the RGB color space, and 58.3% cyan, 43.7% magenta, 0% yellow, and 59.6% black in the CMYK color space, and has a hue angle of 225 degrees, a saturation of 41.1%, and a lightness of 28.6%.

In some examples, the reference color scheme can include a range of colors that gradually increase in lightness (or decrease in lightness depending on direction). By way of non-limiting example, the Virdis color scheme (also referred to as color palette or color map) can be referenced, which ranges from a very dark magenta (e.g., hex #440154, composed of 26.7% red, 0.4% green and 32.9% blue in the RGB color space, composed of 19% cyan, 98.8% magenta, 0% yellow, and 67.1% black in the CMYK color space, and has a hue angle of 288.4 degrees, a saturation of 97.6%, and a lightness of 16.7%) to a vivid yellow (e.g., hex #fde725, composed of 99.2% red, 90.6% green, and 14.5% blue in the RGB color space, composed of 0% cyan, 8.7% magenta, 85.4% yellow, and 0.8% black in the CMYK color space, and has a hue angle of 53.9 degrees, a saturation of 98.2% and a lightness of 56.9%).

In some implementations, the GAI-based application 202 generates a prompt that incorporates at least a portion of the input provided from the user. In some examples, the prompt can be generated using a prompt template that includes static text and placeholders. In general, static text remains static between prompts (e.g., all prompts include the same static text). In some examples, the placeholders are populated based on the input received from the user. An example prompt template can be provided as:
You are an expert graphic designer. Create a visually stunning natural artwork that fits the following description: {{user input}}. The image should be vibrant and dynamic, capturing the core elements and emotions associated with the description. The image must exclusively use hash code colors if they are provided: {{hash color code}}.
   Here, the brackets {{ }} indicate placeholders that are populated based on user input.

In some examples, the prompt can be generated based on use case instructions provided from the user. Use case instructions can include text that is descriptive of what the image is to be based on. For example, example use case instructions can include—Image based on course name: Introduction to Project Management Essentials.

In accordance with implementations of the present disclosure, the prompt includes color instructions that define a reference color scheme that the image is to incorporate. For example, example color instructions can include—The color of the image should follow the color scheme: [#2b3a67, #f4f4f9]. An example prompt can be provided as:
You are an expert graphic designer. Create a visually stunning natural artwork that fits the following description: A simple mountain peak with abstract steps symbolizing achievement and progress. The image should be vibrant and dynamic, capturing the core elements and emotions associated with the description. The image must exclusively use hash code colors if they are provided: [#FF4500, #000000].

In some implementations, the GAI-based application 202 transmits the prompt to the GAI system 204 (e.g., through an application programming interface (API)), which generates and returns an image based on the prompt.

In accordance with implementations of the present disclosure, the GAI-based application 202 provides the image and the reference color scheme to the image alignment evaluation system 206 to determine whether the image aligns with the reference color scheme. More particularly, and as described in further detail herein, the image alignment evaluation system 206 generates a color alignment metric (M_{color}) that can be used to evaluate whether the image aligns with the reference color scheme.

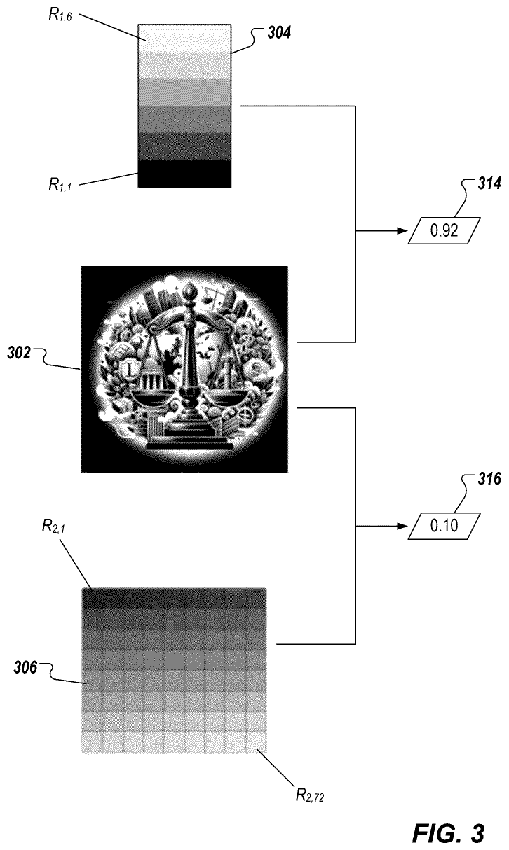

To provide context for color alignment, reference can be made to FIG. 3, which depicts example color alignment evaluations using different color schemes. In the example of FIG. 3, an image 302 is provided and represents an AI-generated image. For example, the prompt that resulted in generation of the image 302 included a reference color scheme that the image 302 was to be based on. In the example of FIG. 3, a first color scheme 304 and a second color scheme 306 are provided (each also referred to as a color map). The first color scheme 304 can be described as a grey-scale color scheme and can range from a first reference color (R_{1,1}) (e.g., #000000; black) to a second reference color (R_{1,6}) (e.g., #d3d3d3; light grey). The second color scheme 306 is provide as the Viridis color scheme and can range from a first reference color (R_{2,1}) (e.g., #440154; very dark magenta) to a second reference color (R_{2,72}) (e.g., #fde725; vivid yellow).

As described in further detail herein, the image 302 can be evaluated for alignment against the first color scheme 304 and the second color scheme 306 to determine respective color alignment metrics 314, 316. In the example of FIG. 3, it is shown that the color alignment metric 314 has a value of 0.9 and the color alignment metric 316 has a value of 0.1. As such, the image 302 is much more aligned with the first color scheme 304 than with the second color scheme 306. In other words, the image 302 conforms much better (is much more accurate) to the first color scheme 304 than to the second color scheme 306.

In some examples, and as described in further detail herein, the color alignment metric is compared to a threshold (Mₜₕᵣ) (e.g., 0.90) to determine whether the image aligns with the reference color scheme provided in the prompt that the image was generated in response to. For example, and with continued reference to FIG. 3, a threshold (Mₜₕᵣ) of 0.90 can be considered. If the reference color scheme (of the prompt) had been the first color scheme 304, it would be determined that the image 302 aligns with the reference color scheme (i.e., 0.92≥0.90). However, if the reference color scheme (of the prompt) had been the second color scheme 306, it would be determined that the image 302 does not align with the reference color scheme (i.e., 0.10<0.90).

Referring again to FIG. 2, the image alignment evaluation system 206 processes the image and the reference color scheme to provide a color alignment metric (M_{color}) and determine whether the image aligns with the reference color scheme. In some implementations, the image is processed by the vectorization module 230 to generate a list of vectors. More particularly, each pixel of the image includes RGB values, where each color channel (8-bit) is represented by an integer ranging from 0, indicating minimal saturation, to 255, indicating maximum saturation. Consequently, the RGB color space can depict a total of 16,777,216 distinct colors. The latest industry standard for enhanced RGB (10-bit) allows for a representation of over 1 billion different colors, significantly improving the capability to preserve colors as perceived by the human eye. In some examples, the vectorization module 230 converts each pixel into a vector based on RGB values (e.g., a vector [0.168 0.277 0.404]). In this manner, and unlike the common approach of analyzing each channel separately, such as using histograms and curve graphs for each channel, implementations of the present disclosure simultaneously consider all three channels to provide higher consistency of results.

In some implementations, the clustering module 232 generates a set of color clusters using the list of vectors. In some examples, the clustering module 232 processes the vectors through an unsupervised K-Means clustering algorithm to partition colors, represented by the vectors in the list of vectors, into distinct clusters based on their respective RGB representations in vector space. As discussed herein, each pixel (and thus color of the pixel) is represented as a vector, and the K-Means clustering algorithm iteratively assigns colors to the nearest cluster centroid, recalculating the centroids based on the mean of the assigned colors. By using K-Means clustering, the vectors of the image are separated into clusters that each include a set of cluster parameters. Example cluster parameters include a cluster centroid and a pixel count. In some examples, the cluster centroid is a vector that represents the color of the cluster. In some examples, the pixel count is the number of pixels in a cluster and is representative of the significance of a color to the image. For example, a blue/green image would have more pixels falling into blue/green color clusters. In some examples, the cluster centroid of a cluster is determined as the average position of all vectors in the respective cluster. This can be computed by taking the mean of each dimension separately across all the vectors in the cluster.

In some implementations, the similarity scoring module 234 generates similarity scores based on the cluster parameters and the reference color scheme. In some examples, to consider the size of each cluster, a weighted arithmetic mean of the cosine similarity score is determined using the following example relationship:

$$\overline{{s}_{q}} = \frac{{\sum }_{i = 1}^{N} {c}_{i} {d}_{i}}{{\sum }_{i = 1}^{N} {c}_{i}}$$

where, dᵢ represents the cosine similarity between the center of cluster i and the q^{th} reference color in the reference color scheme (e.g., [R₁, . . . , Rₘ]), and cᵢ is the number of pixels contained within the cluster i. By summing and dividing by the total number of pixels across all clusters, the similarity scores are normalized. Also, by considering the number of pixels in each cluster, a weighted similarity score is provided, where larger clusters contribute more significantly to the subsequently determined color alignment metric. In this manner, the main colors represented in the image are preserved in the color alignment metric.

In some implementations, the evaluation metric determination module 236 generates the color alignment metric (M_{color}) based on the similarity scores. For example, and as described above with reference to FIG. 3, the reference color scheme can include multiple colors (e.g., a color map). Color maps are used to display a single-band raster where each pixel value corresponds to a specific color. Therefore, it needs to be ensured that the image and the reference color scheme, as a color map, are properly aligned.

To achieve this, in some examples, the evaluation metric determination module 236 performs a calculation between the image and the color map to determine the alignment. Specifically, for each color in the reference color scheme, the corresponding RGB values are extracted and used to calculate a similarity scores with the image, as described above. For example, and with non-limiting reference to the Viridis color map of FIG. 3, seventy-two (72) reference colors are provided. Consequently, a set of similarity scores would include seventy-two similarity scores (e.g., [s₁, . . . , s₇₂]). In some implementations, the color alignment metric (M_{color}) is determined by summing the similarity scores and averaging by dividing the total number of RGB values derived from the color map. This ensures that the color representation of the image accurately matches the selected color map.

In some implementations, the color alignment metric (M_{color}) is processed by the alignment evaluation module 238 to determine a result 240. For example, the alignment evaluation module 238 compares the color alignment metric (M_{color}) to the threshold (Mₜₕᵣ) to generate the result 240. If the color alignment metric (M_{color}) meets or exceeds the threshold (Mₜₕᵣ) color alignment of the image is indicated in the result 240. If the color alignment metric (M_{color}) does not meet or exceed the threshold (Mₜₕᵣ) color misalignment of the image is indicated in the result 240.

In some implementations, the result 240 is provided to the GAI-based application 202 and one or more tasks can be executed in response to the result 240. For example, if the result 240 indicates color alignment of the image (and assuming any other evaluation metrics are met), the image can be used for an intended purpose (e.g., included in training materials). For example, the result 240 can be provided to the user (e.g., in the front end 208) and the user can provide final approval for the image to be used. As another example, if the result 240 indicates color misalignment of the image, the result can be provided to the user (e.g., in the front end 208). In some implementations, the prompt that resulted in the image can be modified (e.g., fine-tuned) and resubmitted to the GAI system 204 in an effort to generate another image that is more aligned with the reference color scheme. For example, a prompt can be fine-tuned by adding an addition instruction (e.g., You must follow the color codes provided and only use colors that are similar the colors.).

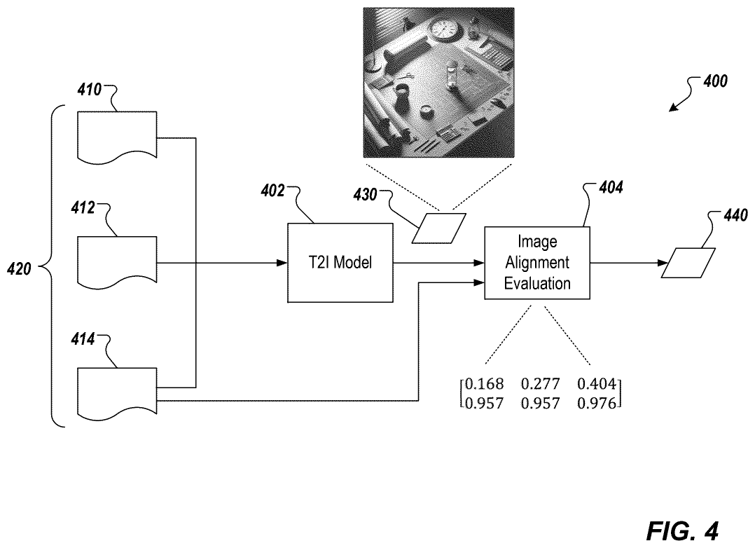

FIG. 4 depicts a pipeline 400 for color alignment evaluation in accordance with implementations of the present disclosure. The example of FIG. 4 includes a T2I model 402 (e.g., provided by the GAI system 204 of FIG. 2) and an image alignment evaluation system 404. In some examples, a prompt template 410, use case instructions 412, and color instructions 414 collectively define a prompt 420 that is used to prompt the T2I model 402. By way of non-limiting example, the prompt 420 instructs the T2I model to generate a cover image for a learning course based on the use case instructions (e.g., the course name) and the color instructions (e.g., a list of color hash codes serving as a reference color scheme). The prompt 420 is processed by the T2I model 402 to generate an image 430, which is evaluated by the image alignment evaluation system 404 based on the color instructions 414. In some examples, a color reference is derived by converting the list of color hash codes into a color scheme matrix. Subsequently, a color alignment score 440 is calculated by comparing the image with the reference color matrix, as described in detail herein. Based on a predefined threshold, images that meet the color alignment criteria are then returned.

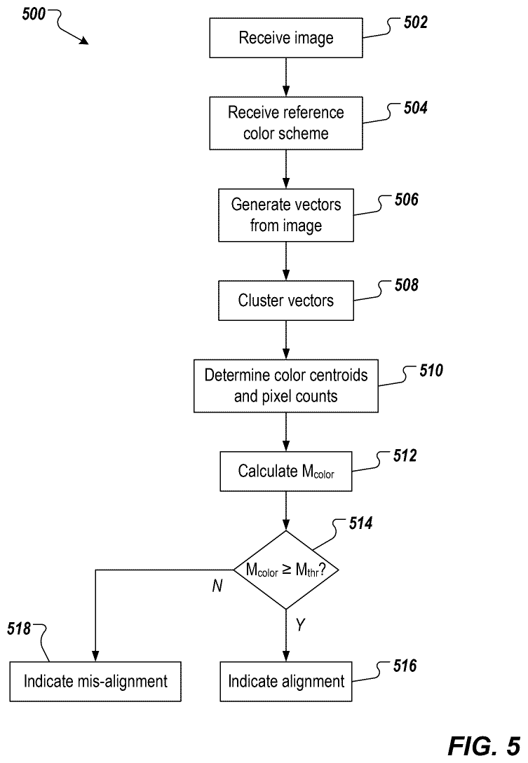

FIG. 5 depicts an example process 500 that can be executed in accordance with implementations of the present disclosure. In some examples, the example process 500 is provided using one or more computer-executable programs executed by one or more computing devices.

An image and a reference color scheme are received (502, 504). For example, and as described herein with reference to FIG. 2, the image alignment evaluation system 206 receives the image and the reference color scheme from the GAI-based application 202. A list of vectors is generated from the image (506). For example, and as described herein, the vectorization module 230 converts each pixel of the image into a vector based on RGB values (e.g., a vector with the RGB values in consecutive order).

The vectors are clustered (508). For example, and as described herein, the clustering module 232 processes the vectors through an unsupervised K-Means clustering algorithm to partition colors, represented by the vectors in the list of vectors, into distinct clusters based on their respective RGB representations in vector space. Color centroids and pixel counts are determined (510). For example, and as described herein, each include a set of cluster parameters. Example cluster parameters include a cluster centroid and a pixel count. In some examples, the cluster centroid is a vector that represents the color of the cluster. In some examples, the pixel count is the number of pixels in a cluster and is representative of the significance of a color to the image.

A color alignment metric (M_{color}) is determined (512). For example, and as described herein, the similarity scoring module 234 generates similarity scores based on the cluster parameters and the reference color scheme and the evaluation metric determination module 236 sums the similarity scores and averages by dividing the total number of RGB values derived from the color map to provide the color alignment metric (M_{color}). It is determined whether the color alignment metric (M_{color}) meets or exceeds a threshold (Mₜₕᵣ) (514). If the color alignment metric (M_{color}) meets or exceeds the threshold (Mₜₕᵣ) color alignment of the image is indicated (516). For example, and as described herein, the color alignment metric (M_{color}) is processed by the alignment evaluation module 238 to determine a result 240. For example, the alignment evaluation module 238 compares the color alignment metric (M_{color}) to the threshold (Mₜₕᵣ) to generate the result 240.

If the color alignment metric (M_{color}) does not meet or exceed the threshold (Mₜₕᵣ) color mis-alignment of the image is indicated (518). In some examples, one or more corrective actions can be executed. For example, the prompt can be modified and another image generated by the GAI system 204.

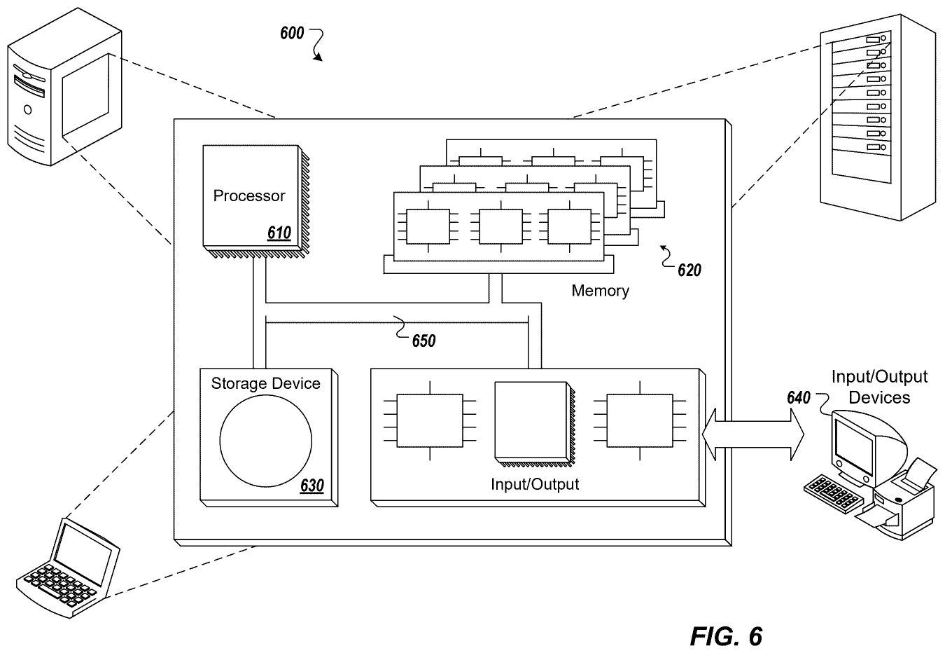

Referring now to FIG. 6, a schematic diagram of an example computing system 600 is provided. The system 600 can be used for the operations described in association with the implementations described herein. For example, the system 600 may be included in any or all of the server components discussed herein. The system 600 includes a processor 610, a memory 620, a storage device 630, and an input/output device 640. The components 610, 620, 630, 640 are interconnected using a system bus 650. The processor 610 is capable of processing instructions for execution within the system 600. In some implementations, the processor 610 is a single-threaded processor. In some implementations, the processor 610 is a multi-threaded processor. The processor 610 is capable of processing instructions stored in the memory 620 or on the storage device 630 to display graphical information for a user interface on the input/output device 640.

The memory 620 stores information within the system 600. In some implementations, the memory 620 is a computer-readable medium. In some implementations, the memory 620 is a volatile memory unit. In some implementations, the memory 620 is a non-volatile memory unit. The storage device 630 is capable of providing mass storage for the system 600. In some implementations, the storage device 630 is a computer-readable medium. In some implementations, the storage device 630 may be a floppy disk device, a hard disk device, an optical disk device, or a tape device. The input/output device 640 provides input/output operations for the system 600. In some implementations, the input/output device 640 includes a keyboard and/or pointing device. In some implementations, the input/output device 640 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier (e.g., in a machine-readable storage device, for execution by a programmable processor), and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. Elements of a computer can include a processor for executing instructions and one or more memories for storing instructions and data. Generally, a computer can also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, for example, a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

A number of implementations of the present disclosure have been described. Nevertheless, it will be understood that various modifications may be made without departing from the spirit and scope of the present disclosure. Accordingly, other implementations are within the scope of the following claims.

What is claimed is:

1. A computer-implemented method for automatically detecting alignment of images generated using artificial intelligence (AI) models to prompts that are input to the AI models, the method being executed by one or more processors and comprising:
receiving an image and a reference color scheme, the image being generated by an AI model, the reference color scheme having populated at least a portion of a prompt that the image was generated in response to;
for each pixel in the image, generating a color space vector representative of a color represented by the pixel to provide a set of vectors;
processing the set of vectors to define a set of clusters, each cluster representative of colors of a sub-set of vectors;
for each cluster in the set of clusters and for each color in the reference color scheme, determining a similarity score that is included in a set of similarity scores;
calculating a color alignment metric based on the set of similarity scores;
determining a color alignment result based on the color alignment metric; and
executing one or more tasks responsive to the color alignment result.

2. The method of claim 1, wherein each color space vector comprises a red channel value, a green channel value, and a blue channel value.

3. The method of claim 1, wherein processing the set of vectors to define a set of clusters comprises processing the set of vectors using a K-means clustering algorithm.

4. The method of claim 1, wherein each similarity score is determined as a cosine similarity between a reference color in the reference color scheme and a cluster centroid of a respective cluster.

5. The method of claim 1, wherein each similarity score is weighted based on a pixel count of a respective cluster.

6. The method of claim 1, wherein the color alignment metric is determined as a sum of similarity scores weighted by a total number of color space values provided in the reference color scheme.

7. The method of claim 1, wherein the one or more tasks comprise modifying the prompt to provide a modified prompt and generating another image using the modified prompt.

8. A non-transitory computer-readable storage medium coupled to one or more processors and having instructions stored thereon which, when executed by the one or more processors, cause the one or more processors to perform operations for automatically detecting alignment of images generated using artificial intelligence (AI) models to prompts that are input to the AI models, the operations comprising:
receiving an image and a reference color scheme, the image being generated by an AI model, the reference color scheme having populated at least a portion of a prompt that the image was generated in response to;
for each pixel in the image, generating a color space vector representative of a color represented by the pixel to provide a set of vectors;
processing the set of vectors to define a set of clusters, each cluster representative of colors of a sub-set of vectors;
for each cluster in the set of clusters and for each color in the reference color scheme, determining a similarity score that is included in a set of similarity scores;
calculating a color alignment metric based on the set of similarity scores;
determining a color alignment result based on the color alignment metric; and
executing one or more tasks responsive to the color alignment result.

9. The non-transitory computer-readable storage medium of claim 8, wherein each color space vector comprises a red channel value, a green channel value, and a blue channel value.

10. The non-transitory computer-readable storage medium of claim 8, wherein processing the set of vectors to define a set of clusters comprises processing the set of vectors using a K-means clustering algorithm.

11. The non-transitory computer-readable storage medium of claim 8, wherein each similarity score is determined as a cosine similarity between a reference color in the reference color scheme and a cluster centroid of a respective cluster.

12. The non-transitory computer-readable storage medium of claim 8, wherein each similarity score is weighted based on a pixel count of a respective cluster.

13. The non-transitory computer-readable storage medium of claim 8, wherein the color alignment metric is determined as a sum of similarity scores weighted by a total number of color space values provided in the reference color scheme.

14. The non-transitory computer-readable storage medium of claim 8, wherein the one or more tasks comprise modifying the prompt to provide a modified prompt and generating another image using the modified prompt.

15. A system, comprising:
a computing device; and
a computer-readable storage device coupled to the computing device and having instructions stored thereon which, when executed by the computing device, cause the computing device to perform operations for automatically detecting alignment of images generated using artificial intelligence (AI) models to prompts that are input to the AI models, the operations comprising:
receiving an image and a reference color scheme, the image being generated by an AI model, the reference color scheme having populated at least a portion of a prompt that the image was generated in response to;
for each pixel in the image, generating a color space vector representative of a color represented by the pixel to provide a set of vectors;
processing the set of vectors to define a set of clusters, each cluster representative of colors of a sub-set of vectors;
for each cluster in the set of clusters and for each color in the reference color scheme, determining a similarity score that is included in a set of similarity scores;
calculating a color alignment metric based on the set of similarity scores;
determining a color alignment result based on the color alignment metric; and
executing one or more tasks responsive to the color alignment result.

16. The system of claim 15, wherein each color space vector comprises a red channel value, a green channel value, and a blue channel value.

17. The system of claim 15, wherein processing the set of vectors to define a set of clusters comprises processing the set of vectors using a K-means clustering algorithm.

18. The system of claim 15, wherein each similarity score is determined as a cosine similarity between a reference color in the reference color scheme and a cluster centroid of a respective cluster.

19. The system of claim 15, wherein each similarity score is weighted based on a pixel count of a respective cluster.

20. The system of claim 15, wherein the color alignment metric is determined as a sum of similarity scores weighted by a total number of color space values provided in the reference color scheme.
